(19) United States
(12) Patent Application Publication
(10) Pub. No.: US 2003/0146918 A1
(43) Pub. Date: Aug. 7, 2003

(54) Appearance modelling

(76) Inventors: Charles Stephen Wiles, London (GB); Mark Jonathan Williams, London (GB); Rhys Andrew Newman, Oxford (GB)

Correspondence Address: FINNEGAN, HENDERSON, FARABOW, GARRETT & DUNNER, LLP, 1300 I STREET, NW, WASHINGTON, DC, 20005, US

(21) Appl. No.: 10/181,488

(22) PCT Filed: Jan. 19, 2001
(86) PCT No.: PCT/GB01/00204

(30) Foreign Application Priority Data
Jan. 20, 2000 (GB) 0001301.1

(51) Int. Cl. G09G 5/00; G06T 17/00

(52) U.S. Cl. 345/582; 345/420

(57) ABSTRACT

A parametric model is provided for modelling the appearance of objects, such as human faces. The model can model both the shape and texture of the object and includes high resolution data which can be used to render high resolution versions of the object from a set of input parameters. In one embodiment, this high resolution texture information is obtained from high resolution texture information derived from a set of training objects.

The present invention relates to the parametric modelling of the appearance of objects. The invention has particular, although not exclusive relevance to the parametric modelling of the appearance of human faces, and the subsequent rendering of a set of appearance parameters into a high resolution 3D face model or image.

The use of parametric models for image interpretation and synthesis has become increasingly popular. Cootes et al have shown in their paper entitled “Active Shape Models—Their Training and Application”, Computer Vision and Image Understanding, Volume 61, No. 1, January, pages 38-59, 1995, how such parametric models can be used to model the variability of the shape and texture of human faces. They have mainly used these models for face recognition and tracking within video sequences, although they have also demonstrated that their model can be used to model the variability of other deformable objects, such as MRI scans of knee joints. The use of these models provides a basis for a broad range of applications since they explain the appearance of a given image in terms of a compact set of model parameters which can be-used for higher levels of interpretation of the image. For example, when analysing face images, they can be used to characterise the identity, pose or expression of a face.

The parametric model proposed by Cootes et al defines a relationship between a set of appearance parameters to either 3D model data or 2D image data of the face described by the parameters. In order to keep the textured data to a manageable size in memory and make the rendering process efficient, the texture data is usually not represented at the highest resolution but at a relatively small number of sampled points (typically 3000 points from a face image area containing 100,000 pixels). During the rendering of the 3D model or 2D image, the missing model data or image data is generated by interpolating between the sampled points. This interpolation results in 3D face models or 2D face images which have a smoothed texture.

One aim of the present invention is to provide an alternative appearance model which includes high frequency texture information.

According to one aspect, the present invention provides a parametric model for modelling the shape and texture of an object, the model comprising: data defining a function which relates a set of appearance parameters to a set of locations which identify the positions of a plurality of predetermined points on the object and to a set of texture values which identify the texture of the object around the predetermined points; characterised by data defining high resolution texture information for the object for combination with the texture values obtained for a current set of appearance parameters, to generate a high resolution representation of the object from the appearance parameters.

According to another aspect, the present invention provides a method of and apparatus for generating appearance data representative of the appearance of an object comprising: a memory for storing data defining a parametric model which relates a set of appearance parameters to a plurality of locations which identify the relative positions of a plurality of predetermined points on the object and to a set of texture values which identify the texture of the object around the predetermined point; means for storing data defining high resolution texture information for the object for combination with the texture values obtained for a current set of appearance parameters to generate a high resolution representation of the object from the appearance parameter; means for generating said plurality of locations and said set of texture values for a received set of appearance parameters using said stored parametric model; and means for combining the texture values with the data defining high resolution texture information to generate a high resolution representation of the object from the received appearance parameters.

An exemplary embodiment of the present invention will now be described with reference to the accompanying drawings in which:

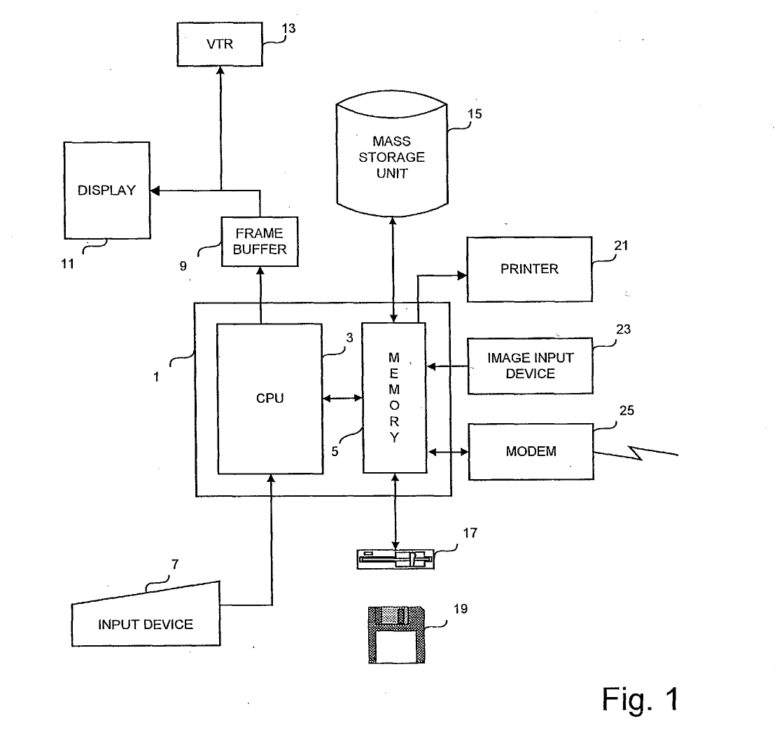

FIG. 1 is a schematic block diagram illustrating a general arrangement of a computer system which can be programmed to implement the present invention;

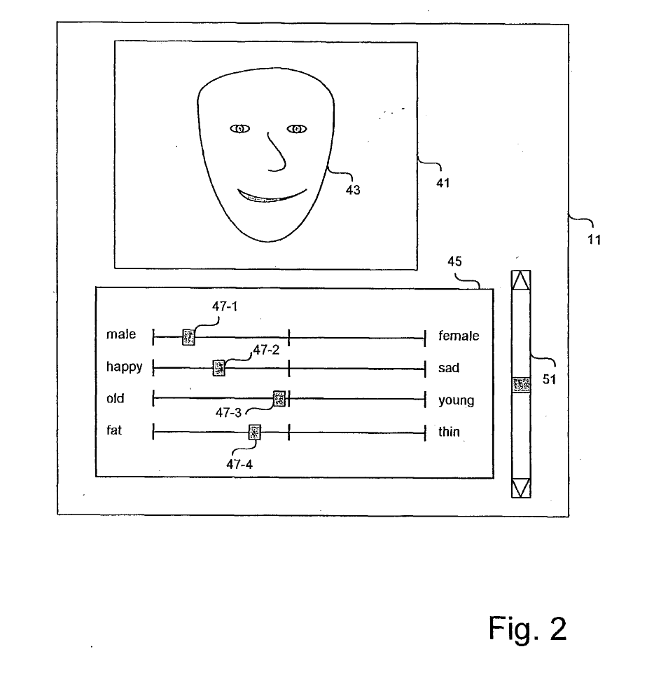

FIG. 2 illustrates a user interface which is displayed on a display of the computer system shown in FIG. 1 which allows users to manipulate the appearance of a displayed face image;

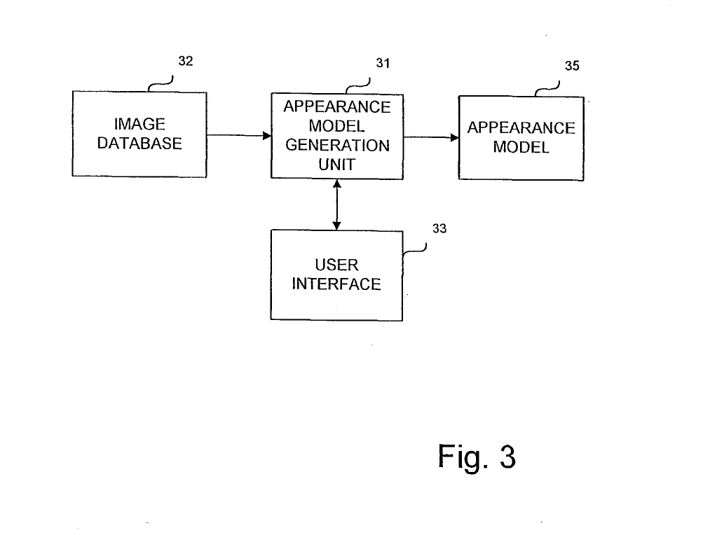

FIG. 3 is a block diagram of an appearance model generation unit which processes training images in a database to generate an appearance model;

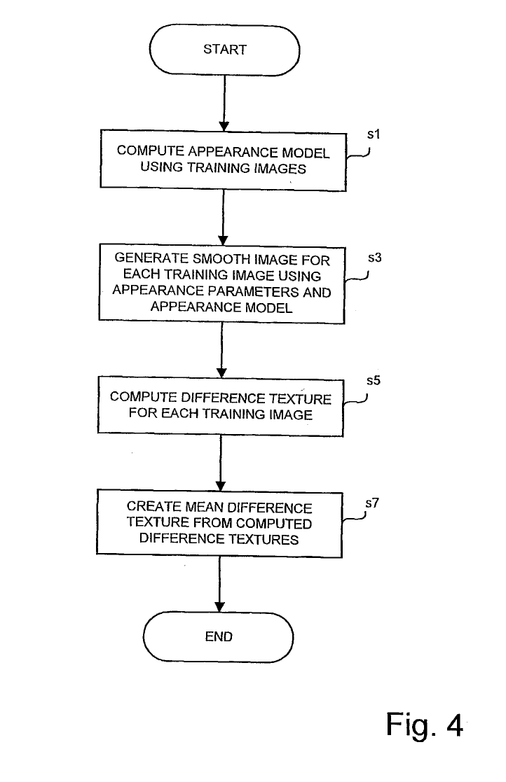

FIG. 4 is a flow chart illustrating the processing steps involved in generating an augmented appearance model embodying the present invention;

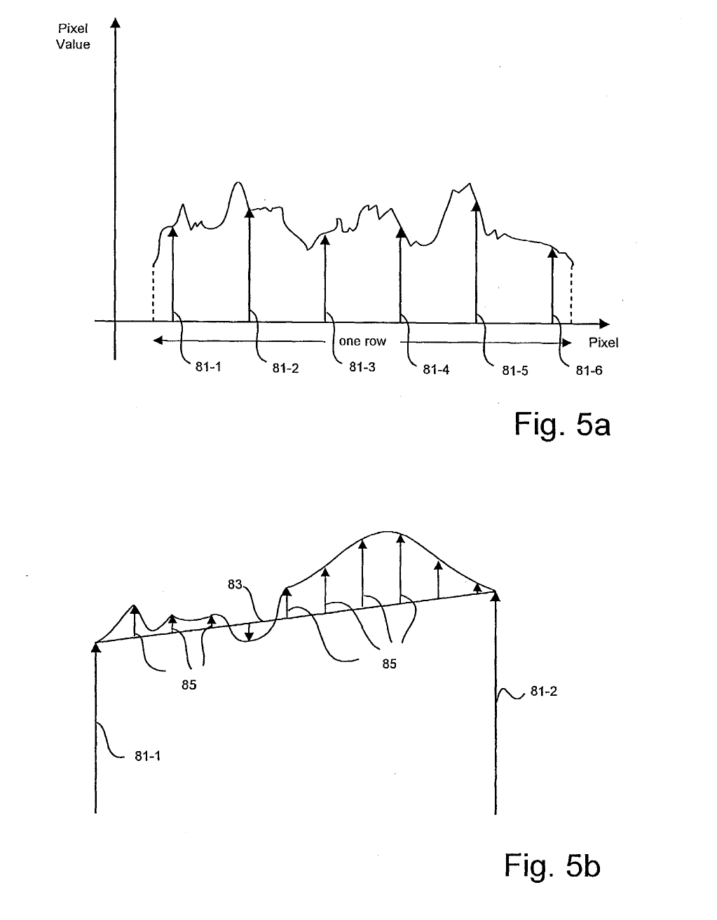

FIG. 5a is a plot illustrating the variation in pixel values over one row of a face image;

FIG. 5b schematically illustrates the way in which difference texture data is generated for the training images; and

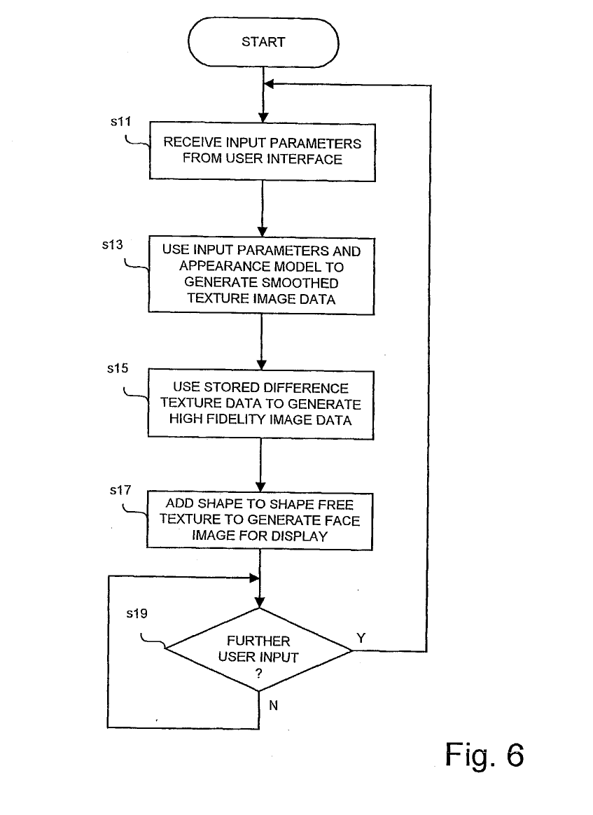

FIG. 6 is a flow chart illustrating the processing steps involved in generating a high resolution image using the augmented appearance model.

FIG. 1 is an image processing apparatus according to an embodiment of the present invention. The apparatus comprises a computer 1 having a central processing unit (CPU) 3 connected to a memory 5 which is operable to store a program defining the sequence of operations of the CPU 3 and to store object and image data used in calculations by the CPU 3. Coupled to an input port of the CPU 3 there is an input device 7, which in this embodiment comprises a keyboard and a computer mouse. Instead of, or in addition to the computer mouse, another position sensitive input device (pointing device) such as a digitiser with associated stylus may be used.

A frame buffer 9 is also provided and is coupled to the CPU 3 and comprises a memory unit (not shown) arranged to store image data relating to at least one image for example by providing one (or several) memory location(s) per pixel of the image. The value stored in the frame buffer for each pixel defines the colour or intensity of that pixel in the image. In this embodiment, the images are represented by 2-D arrays of pixels, and are conveniently described in terms of Cartesian coordinates, so that the position of a given pixel can be described by a pair of x-y coordinates. This representation is convenient since the image is displayed on a raster scan display 11. Therefore, the x-coordinate maps to the distance along the line of the display and the y-coordinate maps to the number of the line. The frame buffer 9 has sufficient memory capacity to store at least one image. For example, for an image having a resolution of 1000×1000 pixels, the frame buffer 9 includes 10⁶ pixel locations, each addressable directly or indirectly in terms of a pixel coordinate x,y.

In this embodiment, a video tape recorder (VTR) 13 is also coupled to the frame buffer 9, for recording the image or sequence of images displayed on the display 11. A mass storage device 15, such as a hard disc drive, having a high data storage capacity is also provided and coupled to the memory 5. Also coupled to the memory 5 is a floppy disc drive 17 which is operable to accept removable data storage media, such as a floppy disc 19 and to transfer data stored thereon to the memory 5. The memory 5 is also coupled to a printer 21 so that generated images can be output in paper form, an image input device 23 such as a scanner or video camera and a modem 25 so that input images and output images can be received from and transmitted to remote computer terminals via a data network, such as the Internet. The CPU 3, memory 5, frame buffer 9, display unit 11 and mass storage device 13 may be commercially available as a complete system, for example as an IBM compatible personal computer (PC) or a workstation such as the Spark station available from Sun Microsystems.

A number of embodiments of the invention can be supplied commercially in the form of programs stored on a floppy disc 19 or on other mediums, or as signals transmitted over a data link, such as the Internet, so that the receiving hardware becomes reconfigured into an apparatus embodying the present invention.

In this embodiment, the computer 1 is programmed to display a model face generated by an appearance model on the display 11 together with a user interface which allows the user to change the appearance of the displayed face by manipulating a set of appearance parameters which represent the face via the appearance model. FIG. 2 illustrates the user interface which is displayed on the display 11. As shown, there is a box 41 in which the model face 43 for the current set of appearance parameters is displayed. Underneath this box there is a user interface 45 which displays a number of sliders 47-1 to 47-4 which are used to vary some of the appearance parameters in order to change the appearance of the displayed face 43. As shown in FIG. 2, the slider 47-1 is used to vary the appearance of the face between a male face and a female face; slider 47-2 is used to vary the expression of the displayed face between a happy face and a sad face; slider 47-3 is used to vary the displayed face 43 between an old face and a young face; and slider 47-4 is used to change the displayed face 43 between a fat face and a thin face. Other sliders to vary other aspects of the displayed face 43 are provided which can be accessed via the scroll bar 51. The way in which this is achieved will now be described in more detail with reference to FIGS. 3 to 6.

In order to be able to modify the displayed face, an appearance model which models the variability of shape and texture of face images is used and which relates a set of parameter values (defined by the slider values) to image pixel data. This appearance model makes use of the fact that some prior knowledge is available about the contents of face images in order to facilitate their modelling. For example, it can be assumed that two frontal images of a human face will each include eyes, a nose and a mouth. In order to create the appearance model, a number of landmark points are identified on a training image and then the same landmark points are identified on the other training images in order to represent how the location of and pixel values around the landmark points vary within the training images. A principal component analysis is then performed on the matrix which consists of vectors of the landmark points and vectors of the pixel values around the landmark points. This principal component analysis yields a set of Eigenvectors which describe the directions of greatest variation in the training data. The appearance model includes the linear combination of Eigenvectors plus parameters for translation, rotation and scaling.

In order that this appearance model can model the variability of all human faces, the training images should include a large collection of different individuals of all nationalities and images showing the greatest variation in facial expressions and 3D pose. In this embodiment, as shown in FIG. 3, the parametric appearance model 35 is generated by an appearance model generation unit 31 from training images which are stored in an image database 32. In this embodiment, all the training images are colour images having 500×500 pixels, with each pixel having a red, green and blue pixel value. The resulting appearance model 35 is a parameterisation of the appearance of the class of head images defined by the heads in the training images, so that a relatively small number of parameters (for example 80) can describe the detailed (pixel level) appearance of a head image from the class. In particular, the appearance model 35 defines a function (F) such that:

I=F(\overline{p}) (1)

where \overline{p} is the set of appearance parameters (written in vector notation) which generates, through the appearance model (F), the face image I. For more information on this appearance model and how it can be used to parameterise an input image or generate an output image from an input set of parameters, the reader is referred to the above mentioned paper by Cootes et al, the content of which is incorporated herein by reference. In this embodiment, these appearance parameters correspond to the values which can be manipulated by the sliders 47 in the user interface 45. In some cases, however, there will not be a one-to-one correspondence between the parameters in the vector \overline{p} and the parameters which can be manipulated within the user interface 45. For example, the happy/sad slider 47-2 may affect the value of more than one of the parameters within the set of appearance parameters (\overline{p}). In this case, the relationship between the slider values and the corresponding change in some of the appearance parameters can be learned through suitable training.

In order to be able to make the changes to the face 43 displayed in the box 41 in substantially real time, the appearance model only generates pixel data at a relatively low resolution compared to the original resolution of the training images. Typically, the appearance model will generate approximately 3000 pixel values of a face image which might originally have contained approximately 100,000 pixels. The pixel values between these generated pixel values are then initially obtained by interpolating between neighbouring pixel values. In this embodiment, in order to regenerate a higher resolution face image, the interpolated pixel values are combined with pre-stored high resolution texture information which is obtained from the training images during the training routine.

FIG. 4 shows a flow chart illustrating the steps involved in the training routine used in this embodiment. As shown, in step s1, the system computes the above described appearance model (F) using the training images stored in the image database 32. Then, in step s3, the system uses the generated appearance model and the appearance parameters for each of the training images to generate a smooth version of each of the training images (the model image) by interpolating between the pixel values generated by the model. In this embodiment, the appearance model actually generates, for each training image, a shape-free texture image together with shape information which defines how the shape-free texture image should be warped to produce the model image. Then, in step s5, the system computes difference texture information for each of the training images by comparing the interpolated pixel values of the shape-free image with the corresponding actual pixel values obtained from a shape-free version of the training image obtained by warping the training image using the shape information. The way that this difference texture information is calculated is diagrammatically illustrated in FIG. 5.

In particular, FIG. 5a illustrates a plot of the variation of the actual pixel values from one row of a shape-free version of a training image. The arrows 81 shown in FIG. 5a represent the pixel values which are generated by the appearance model. FIG. 5b illustrates a portion of this row of pixels between the model generated pixel represented by the arrow 81-1 and the model generated pixel value represented by the arrow 81-2. In this embodiment, a linear interpolation is performed between the pixel values generated by the model. This is illustrated in FIG. 5b by the straight line 83. In step s5 shown in FIG. 4, the system calculates the pixel differences (represented by the arrows 85) between the interpolated pixel values (determined from the line 83) and the actual pixel values in the shape-free training image. The result will be a two-dimensional difference texture “image” having 500×500 difference texture values which contain the high frequency texture information of the training image.

Returning to FIG. 4, in this embodiment, after this difference texture information is generated for each of the shape-free training images in the image database 32, the system creates, in step s7, a mean difference texture image from the difference texture images generated for all of the training images. In this embodiment, this is achieved by averaging the corresponding difference texture values in all the generated difference texture images. In other words, the difference texture value for pixel (i,j) is calculated from:

$$\overline{d} ( i , j ) = \frac{1}{N} {\sum }_{n = 1}^{N} {d}^{n} ( i , j ) \qquad ( 2 )$$

where dⁿ(i,j) is the (i,j) difference texture value from the difference texture image for the nth shape-free training image and N is the number of training images in the image database 32. As those skilled in the art will appreciate, the average of the corresponding difference texture values in the difference texture images can be taken because there is a one-to-one correspondence in the pixel locations of the shape-free training images. Once this mean difference texture information has been determined in step s7, it is added to the appearance model (F) and used in subsequent processing to add high resolution texture information to the smooth images generated by the appearance model (F).

FIG. 6 shows a flow chart illustrating the way in which the computer system 1 in this embodiment generates the face images 43 displayed in the box 41 shown in FIG. 2. Initially, in step s11, the computer system 1 receives the current set of input parameters from the user interface 45. These input parameters are then input to the appearance model 35 which generates a smooth shape-free texture image corresponding to the input appearance parameters. Then, in step s15, the computer system 1 adds the stored difference texture image to the smooth shape-free image generated in step s13 to generate a high resolution shape-free image. Then, in step s17, the system adds the shape information for the current input parameters determined by the appearance model 35 to generate the corresponding face image for display in the box 41. The processing then proceeds to step s19 where the computer system 1 awaits the next user input before returning to step s11.

### ALTERNATIVE EMBODIMENTS

In the above embodiment, the difference texture information stored with the appearance model was a mean difference texture “image” derived from the training images. As those skilled in the art will appreciate, rather than taking a simple mean difference texture image, some other combination of the training difference texture images may be used. For example, the difference texture images generated for some of the training images might be grouped depending upon some attribute of the faces in the training images. For example, the difference texture images for young males might be grouped and an average for them generated and those for young females grouped and averaged in a similar manner. In this way, more than one difference texture image might be stored with the appearance model. Subsequently, during regeneration of a face image one of the difference texture images stored with the appearance model could be selected on the basis of the appearance parameters input by the user. For example, if the user wants to display a young male, then the corresponding difference texture data can be retrieved and used to generate the high resolution model image. Alternatively, a weighted combination of some of the stored difference texture images may be used to add high resolution texture information to the face generated by the model.

In the above embodiment, a smooth textured image was generated from the pixel data generated by the appearance model using a linear interpolation between the generated pixel values. As those skilled in the art will appreciate, other interpolation functions could be used, such as spline curves etc, provided the same interpolation function is used for each training image and in the subsequent image regeneration processing.

In the above embodiment, the appearance model developed by Cootes et al was used in order to model the appearance of face images. Other types of parametric appearance models may be used, such as the hierarchical appearance model described in the applicant's co-pending UK application GB 9927314.6 filed 18 Nov. 1999, the content of which is incorporated herein by reference.

In the above embodiments, the appearance model was determined from a principal component analysis of a set of training data. This principal component analysis determined a linear relationship between the training data and a set of model parameters. As those skilled in the art will appreciate, techniques other than principal component analysis can be used to determine a parametric model which relates a set of parameters to the training data. This model may define a non-linear relationship between the training data and the model parameters. For example, the model may comprise a neural network.

In the above embodiments, the appearance model was used to model the variations in facial expressions and 3D pose of human heads. As those skilled in the art will appreciate, the appearance model can be used to model the appearance of any deformable object such as parts of the body and other animals and objects.

In the above embodiments, the training images used to generate the appearance model were all colour images in which each pixel had an RGB value. As those skilled in the art will appreciate, the way in which the colour is represented in this embodiment is not important. In particular, rather than each pixel having a red, green and blue value, they might be represented by a chrominance and a luminance component or by hue, saturation and value components. Alternatively still, the training images may be black and white images in which case only grey level data would be extracted from the training images. Additionally, the resolution of each training image may be different.

In the above embodiment, the appearance model was used to model variations in two-dimensional training images. As those skilled in the art will appreciate, the above modelling technique can be used to model the variation between 3D images and animations. In such an embodiment, the training images used to generate the appearance model would normally include the surface texture images of a 3D model instead of 2D images. The three-dimensional models may be obtained using a three-dimensional scanner which typically work either by using laser range-finding over the object or by using one or more stereo pairs of cameras. Once a 3D appearance model has been created from the training models, new 3D models can be generated by adjusting the appearance parameters using the same techniques described above.

In the above embodiment, a high resolution texture difference image was added to a low resolution texture image generated from an appearance model from an input set of appearance parameters. As those skilled in the art will appreciate, a similar technique can be used to generate high resolution shape data where the model and the appearance parameters only generate low resolution shape data. This technique would be particularly useful when the shape model models the 3D shape of the object. The way that such an embodiment would work will now be briefly described where the shape model models the 3D shape of a human face.

In order to generate the high resolution shape difference data and the low resolution shape model, 3D training images are required. To generate the low resolution shape model, the 3D point coordinates of the corners of a low resolution triangular faceted mesh consisting of, for example, 50 facets are placed over each of the training faces. The variation in these 3D point coordinates of the training faces is then modelled by, for example, taking a principle component analysis on the data. This analysis defines a relationship between the 3D point coordinates of the corners of the low resolution mesh to a set of shape parameters.

In order to determine the high resolution shape difference data, a high resolution triangular faceted mesh comprising of, for example, 2000 facets must be fitted to the training images. The high resolution shape difference data would then be calculated as a set of difference vectors between the corners of the high resolution mesh and the corresponding corners of the high resolution mesh when projected onto the corresponding facet of the low resolution mesh. The corresponding vectors for each of the training images could then be averaged to generate the high resolution shape difference data which can be combined with the low resolution shape data generated by the shape model to produce high resolution shape data.

In the above embodiment, a tool has been described which allows users to modify the appearance of a displayed face. As those skilled in the art will appreciate, this tool can be used, for example, for animation purposes. This technique can also be used in order to allow the efficient transmission of images. In particular, by transmitting just the appearance parameters, a high resolution face image can be regenerated at the receiver using an appropriate appearance model and high resolution texture information.

1. A parametric model for modelling the shape and texture of an object, the model comprising:
data defining a function which relates a set of input parameters to a set of locations which identify the relative positions of a plurality of predetermined points on the object and to a set of texture values which identify the texture of the object around the predetermined points;
characterised by data defining high resolution texture information for the object for combination with the texture values obtained for a current set of input parameters, to generate a high resolution representation of the object from the input parameters.

2. A model according to claim 1, for modelling the two-dimensional shape of the object by identifying the relative positions of said predetermined points in a predetermined plane.

3. A model according to claim 1, for modelling the three-dimensional shape of the object by identifying the relative positions of the predetermined points in a three-dimensional space.

4. A model according to any preceding claim, wherein said function linearly relates the input parameters to the set of locations and texture values.

5. A model according to claim 4, wherein said linear function is identified from a principal component analysis of training data derived from a set of training objects.

6. A model according to any preceding claim, wherein said object is a deformable object.

7. A model according to claim 6, wherein said deformable object includes a human face.

8. A model according to any preceding claim, wherein said high resolution texture information is obtained from training data derived from a set of training objects.

9. A model according to claim 8, wherein said data defining said high resolution texture information is obtained by determining a smooth representation of each training object by using an interpolation function between the texture values generated by the model for the training object and from actual texture information of the training object.

10. A model according to claim 9, wherein said data defining said high resolution texture information is obtained by determining difference texture information for each training object which defines the difference between the interpolated texture values and the actual texture information of the training object.

11. A model according to claim 10, wherein said data defining said high resolution texture information is obtained by averaging the difference texture information obtained for each training object.

12. A model according to any of claims 8 to 11, further comprising further data defining different high resolution texture information obtained from a different set of training objects.

13. A parametric model for modelling the shape of an object, the model comprising:
data defining a function which relates a set of input parameters to a set of locations which identify the relative positions of a plurality of predetermined points on the object;
characterised by data defining high resolution shape information for the object for combination with the locations obtained for a current set of input parameters, to generate a high resolution representation of the object from the input parameters.

14. A parametric model according to claim 13, for modelling the three-dimensional shape of the object by identifying the relative positions of the predetermined points in a three-dimensional space.

15. A method of generating appearance data representative of the appearance of an object, the method comprising the steps of:
(i) storing data defining a parametric model which relates a set of appearance parameters to a set of locations which identify the relative positions of a plurality of predetermined points on the object and to a set of texture values which identify the texture of the object around the predetermined point;
(ii) storing data defining high resolution texture information for the object for combination with the texture values obtained for a current set of appearance parameters, to generate a high resolution representation of the object from the appearance parameters;
(iii) receiving a set of appearance parameters;
(iv) using said stored parametric model to generate said set of locations and said set of texture values for the received set of appearance parameters; and
(v) combining said texture values with said data defining high resolution texture information to generate a high resolution representation of the object from the appearance parameters.

16. A method according to claim 15, wherein said combining step generates a high resolution 2D image of the object.

17. A method according to claim 15, wherein said combining step generates a high resolution 3D model of the object.

18. A method according to any of claims 15 to 17, wherein said high resolution texture information is obtained from training data derived from a set of training objects.

19. A method according to claim 18, wherein said data defining said high resolution texture information is obtained by determining a smooth representation of each training object by using an interpolation function between the texture values generated by the model for the training object and from actual texture information of the training object.

20. A method according to claim 19, wherein said data defining said high resolution texture information is obtained by determining difference texture information for each training object which defines the difference between the interpolated texture values and the actual texture information of the training object.

21. A method according to claim 20, wherein said data defining said high resolution texture information is obtained by averaging the difference texture information obtained for each training object.

22. A method according to claim 20 or 21, wherein said combining step generates said high resolution representation of the object by determining a smooth representation of the object by using an interpolation function between the texture values generated by the model and by adding said difference texture information to the interpolated texture values.

23. A method according to claim 22, wherein said model is operable to generate shape information from said set of input appearance parameters and wherein after said combining step, said shape information is used in order to give shape to the representation of the object.

24. A method according to any of claims 15 to 23, wherein plural data defining high resolution texture information are stored and further comprising the step of selecting the high resolution texture data to be combined with the texture values generated by the model.

25. A method according to claim 24, wherein said selecting step is automatic and depends upon the received appearance parameters.

26. A method according to any of claims 15 to 25, wherein said object is a deformable object.

27. A method according to claim 26, wherein said deformable object includes a human face.

28. A method according to any of claims 15 to 27, wherein said parametric model linearly relates the received appearance parameters to said set of locations and said set of texture values.

29. A method according to claim 28, wherein said parametric model is identified from a principal component analysis of training data derived from a set of training objects.

30. A method of generating appearance data representative of the appearance of an object, the method comprising the steps of:
(i) storing data defining a parametric model which relates a set of appearance parameters to a set of locations which identify the relative positions of a plurality of predetermined points on the object;
(ii) storing data defining high resolution shape information for the object for combination with the locations obtained for a current set of appearance parameters, to generate a high resolution representation of the object from the appearance parameters;
(iii) receiving a set of appearance parameters;
(iv) using the stored parametric model to generate said set of locations for the received set of appearance parameters; and
(v) combining said locations with said data defining high resolution shape information to generate a high resolution representation of the object from the appearance parameters.

31. An apparatus for generating appearance data representative of the appearance of an object, the apparatus comprising:
means for storing data defining a parametric model which relates a set of appearance parameters to a set of locations which identify the relative positions of a plurality of predetermined points on the object and to a set of texture values which identify the texture of the object around the predetermined point;
means for storing data defining high resolution texture information for the object for combination with the texture values obtained for a current set of appearance parameters, to generate a high resolution representation of the object from the appearance parameters;
means for receiving a set of appearance parameters;
means for generating said set of locations and said set of texture values for the received set of appearance parameters using said stored parametric model; and
means for combining said texture values with said data defining high resolution texture information to generate a high resolution representation of the object from the appearance parameters.

32. An apparatus according to claim 31, wherein said combining means is operable to generate a high resolution 2D image of the object.

33. An apparatus according to claim 31, wherein said combining means is operable to generate a high resolution 3D model of the object.

34. An apparatus according to any of claims 31 to 33, wherein said high resolution texture information is obtained from training data derived from a set of training objects.

35. An apparatus according to claim 34, wherein said data defining said high resolution texture information is obtained by determining a smooth representation of each training object by using an interpolation function between the texture values generated by the model for the training object and from actual texture information of the training object.

36. An apparatus according to claim 35, wherein said data defining said high resolution texture information is obtained by determining difference texture information for each training object which defines the difference between the interpolated texture values and the actual texture information of the training object.

37. An apparatus according to claim 36, wherein said data defining said high resolution texture information is obtained by averaging the difference texture information obtained for each training object.

38. An apparatus according to claim 36 or 37, wherein said combining means is operable to generate said high resolution representation of the object by determining a smooth representation of the object by using an interpolation function between the texture values generated by the model and by adding said difference texture information to the interpolated texture values.

39. An apparatus according to claim 38, wherein said model is operable to generate shape information from said set of appearance parameters and further comprising means for adding shape to the representation of the object using said shape information.

40. An apparatus according to any of claims 31 to 39, wherein plural data defining high resolution texture information are stored and further comprising means for selecting the high resolution texture data to be combined with the texture values generated by the model.

41. An apparatus according to claim 40, wherein said selecting means is operable to select the high resolution texture data in dependence upon the received appearance parameters.

42. An apparatus according to any of claims 31 to 41, wherein said object is a deformable object.

43. An apparatus according to claim 42, wherein said deformable object includes a human face.

44. An apparatus according to any of claims 31 to 43, wherein said parametric model linearly relates the received appearance parameters to said set of locations and said set of texture values.

45. An apparatus according to claim 44, wherein said parametric model is identified from a principal component analysis of training data derived from a set of training objects.

46. An apparatus for generating appearance data representative of the appearance of an object, the apparatus comprising:
means for storing data defining a parametric model which relates a set of appearance parameters to a set of locations which identify the relative positions of a plurality of predetermined points on the object;
means for storing data defining high resolution shape information for the object for combination with the locations obtained for a current set of appearance parameters, to generate a high resolution representation of the object from the appearance parameters;
means for receiving a set of appearance parameters;
means for generating said set of locations for the received set of appearance parameters using said stored parametric model; and
means for combining said locations with said data defining high resolution shape information to generate a high resolution representation of the object from the appearance parameters.

47. A storage medium storing the model according to any of claims 1 to 14 or storing processor implementable instructions for controlling a processor to implement the method of any one of claims 15 to 30.

48. Processor implementable instructions for controlling a processor to implement the method of any one of claims 15 to 30.
